(19) United States
(12) Patent Application Publication
(10) Pub. No.: US 2004/0120577 A1
(43) Pub. Date: Jun. 24, 2004

(54) Digital video based array detector for parallel process control and radiation driver for micro-scale devices

(75) Inventor: Igor V. Touzov, Cary, NC (US)

Correspondence Address: IGOR V TOUZOV, 311 CASTLE HAYNE DRIVE, CARY, NC, 27519, US

(73) Assignee: Igor V. Touzov, Cary, NC (US)

(21) Appl. No.: 10/605,516

(22) Filed: Oct. 5, 2003

Related U.S. Application Data
(60) Provisional application No. 60/416,761, filed on Oct. 6, 2002.

(51) Int. Cl. G06K 9/46; G06K 9/66; G02B 26/00; G01B 11/24; G01B 11/30

(52) U.S. Cl. 382/190; 359/290; 356/601

(57) ABSTRACT

Invention discloses apparatus for parallel monitoring and control of arrays of similar processes. Method and apparatus for metrological control of planar arrays of micro-devices. Method and apparatus for remote radiation driver that actuates large linear and planar arrays of micro and nano devices. Methods include control of micro stamps arrays and arrays of microcantilevers.

### CROSS REFERENCE TO RELATED APPLICATIONS

This application is a regular application of provisional Patent Application No. 60/416,761, filed Oct. 6, 2002 which is hereby incorporated by reference in its entirety for all purposes

### BACKGROUND OF INVENTION

Development of diverse set of applications that employs micro and nano scale properties of matter created equally wide range of equipment that is able to operate at such small scales. One of primary advantages of such technologies is ability to efficiently and cheaply employ parallel processing for large number of entities. These parallel technologies have been developed for processing of thousands and even millions of chemicals on a single microfluidic/microarray device. Microoptical devices accounts several millions of parallel processing channels suitable for diverse tasks such as maskless lithography, printing, network switching, etc. Micromechanical and micro-electro mechanicals systems are capable of simultaneous execution of thousands and sometimes millions of simultaneous mechanical operations required for microfluidics, microoptics and micromachining.

One of essential benefits of such parallel systems is their ability to slice operation cost, while providing new level of technological performance. Yet new demands for high-volume serial processing of highly parallel micro systems have raised. Bright examples of these demanding technologies are high-throughput screening, high-throughput synthesis, soft lithography, maskless lithography, and dip pen lithography. Regardless of cost of microdevices employed in said technologies, demands for high-volume serial processing including conveyer approaches result in significant total operating cost. That is why approaches for reduction of individual (per device) cost become important factor defining comparative commercial benefits of one versus another microdevices capable of performing similar tasks.

One of directions in reducing individual cost is simplification of construction and available functions of said microdevices and relocation of their implementation into hosting macro device that supports operations of said microdevices. Since hosting device has long service live its operational cost contribute only tiny fraction to technological process it involved into. That is why it is economically beneficial to increase cost of said hosting device by transferring as many technological steps into its construction instead of implementing the same in corresponding microdevices. The role of said microdevices then become a simple interface or an adapter for parallel processing.

Instead of self sufficient microdevice that performs required tasks with minimal external aid, in cases of high-volume technological processes (conveyer), simple microdevice requiring sophisticated interface and hosting equipment provides better commercial performance.

The present invention closely relates to said hosting equipment and implements optical interface with various microarray, microfluidic, micromechanical, and micro-electromechanical devices. In one aspect it is important top provide efficient means for analysis as well as quality control for microarray applications. One of examples includes arrays with hundreds of thousands of microdroplets deposited and dried on said microarray. Aspects of quality control include consistence of amounts and locations of deposited substances. Existing technologies that address these demands use microoptical spectroscopic techniques to validate deposition steps. Although there are many advantages of said approach it is not sensitive to geometrical factors of deposition. Said microarray may contain contaminants that are not detectable via spectroscopic testing. Such contaminants may include inorganic particles, or low-molecular weight monolayer that left undetected result in unexpected loss of functionality of said microarray.

The present invention provides method of efficient analysis for described validation and discloses device capable of implementing said method.

In one aspect the present invention describes device and method for real-time control of micromechanical or micro-electromechanical devices. In one particular application scenario micromechanical devices are employed for performing maskless lithography operations on plurality of substrates. The term of use is constrained by mechanical wear of contact elements of said microdevices. Examples of such application comprise microcontact printing technology, multi-cantilever scanning probe microscopy (in applications to metrological control). Mechanical wear usually caused by interactions between nano-scale sized features of said devices with substrate surface. Such wear causes degradation of process quality. Some of said devices require feedback control to satisfy process requirements. Implementation of sensory elements as an integral part of these microdevices significantly increase their cost. Contrary to that use of similar devices that contain no feedback control elements as a replaceable part of holding device, wherein said holding device provides all required feedback and sensory features can provide more efficient and cheaper solution for the same process.

### SUMMARY OF INVENTION

The present invention discloses original method for qualitative and quantitative characterization of nano-scale deposits arrays. Said method uses changes in mode of laser beam caused by peculiarities of reflecting surface in focal point. Method allows detection of nanometer scale deposits without use of shortwave radiation. It employs single mode laser radiation in infrared, visible or UV range. Device that implements said method also disclosed. It comprises CCD sensor element that captures array of reflected beams and decodes alterations in their position and intensity distribution.

One embodiment of the invention describes the apparatus that employs two or three axis positional stage that engaged in scanning of said microarray. Disclosed device and associated method provides improved accuracy and allows compensation for systematic errors in array geometry.

Apparatus allowing remote real-time control of operation for micromechanical and micro-electromechanical devices comprises CCD sensor element that register laser radiation reflected from plurality of said micromechanical elements. Digital processing device extracts distortion data from provided digital video stream, wherein said distortions comprise time and amplitude. These parameters correspond to geometrical distortions and intensity. Decoded information then employed for feedback control of said microdevice and provides in-process quality control.

In one embodiment said apparatus uses high power laser source to supply direct energy to said microdevice. the Apparatus comprises DLP (digital light processing ) element that controls timing and amount of supplied energy. This energy is then employed as means for thermal control of said microdevice, or used as a driving force that converted to mechanical motion/displacement, or acoustic wave that drives mechanical oscillations.

### BRIEF DESCRIPTION OF DRAWINGS

FIG. 1 show in process monitoring use of digital video detector.

FIG. 2 shows optical system with selective filtering.

FIG. 3 shows serial detector operating on digital video stream.

FIG. 4 shows frame based extraction of detector data.

FIG. 5A shows parallel metrology detector.

FIG. 5B shows parallel metrology detector employing array of micro lenses.

FIG. 6 shows modulation of laser beam mode.

FIG. 7 shows schematic block diagram of scanning parallel detection method.

FIG. 8 shows method of monitoring geometrical distortions of silicon wafer.

FIG. 9 shows diagram of radiation driver for micromechanical devices.

FIG. 10 shows diagram illustrating use of radiation driver to produce controlled deformations on large array of microcantilevers.

FIG. 11 shows principle of creation controlled resonance oscillations of cantilever.

FIG. 12 shows principle of operation of massively parallel driver with multi-channel parallel detector.

### DETAILED DESCRIPTION

This description operates with some common terms that have special meaning in this document. Digital video—corresponds to device capable of capturing sequence of optical images in some range of radiation spectrum. This device provides monochrome or color data. This data may be originally digital or can be transformed into digital format from analog data. Beam splitter—optical device that converts single light source into multiple beams with static geometry.

Digital Video Detector for Massively Parallel Process Control

The apparatus comprises digital video acquisition device, optical system and digital processing device that extracts distortion data from digital video stream. The apparatus is designed for registration of distortion data for large number of similar processes that occur within field of view of the optical system.

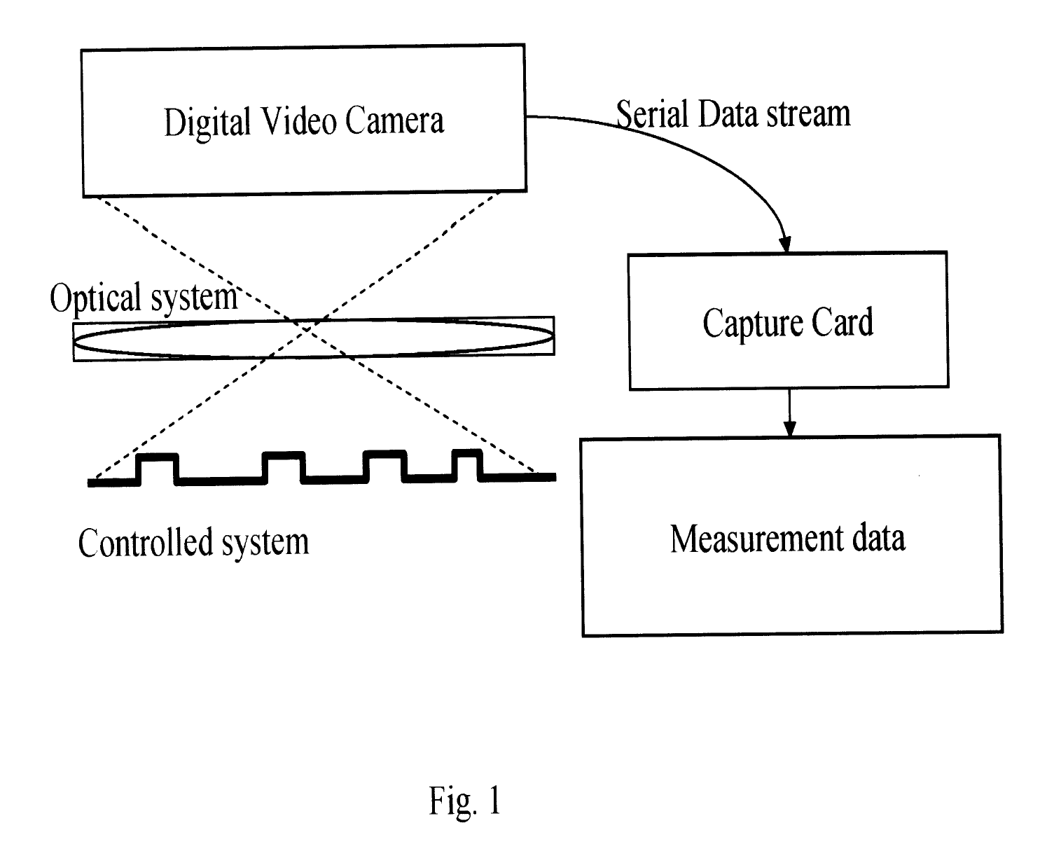

This apparatus allows registration of large number of similar events that occur nearly at the same time. Schema of this process is illustrated on FIG. 1. Information about said events processed through the optical system. The optical system enhances SNR (signal to noise ratio) for selected types of events. The video acquisition system registers the image built by the optical system. The progression of said image is transmitted in serial form of digital video stream to video capture/processing system. The processing system extracts event information for each individual event from the digital video stream. The collection of data associated with an individual physical location over the time makes a time sequence of events at said location. Collection of all sequences provides data for whole multiplicity of registered events.

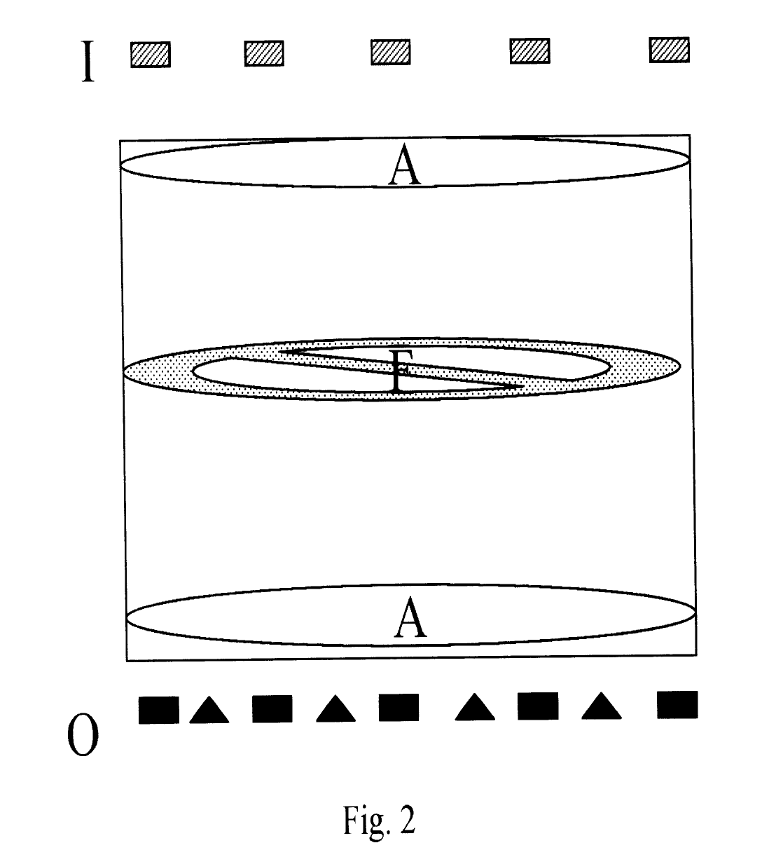

The optical system constructs an Image of controlled system for digital video acquisition device. FIG. 2 illustrates design of this system. Optical components “A” of this system construct an image “I” of the area “O” within its field of view. In some cases this system also contains filtering subsystem “F” that increases SNR for selected features of area “O”. This filtering can be based on depth of optical field, color, polarization, spatial positions, and/or shapes.

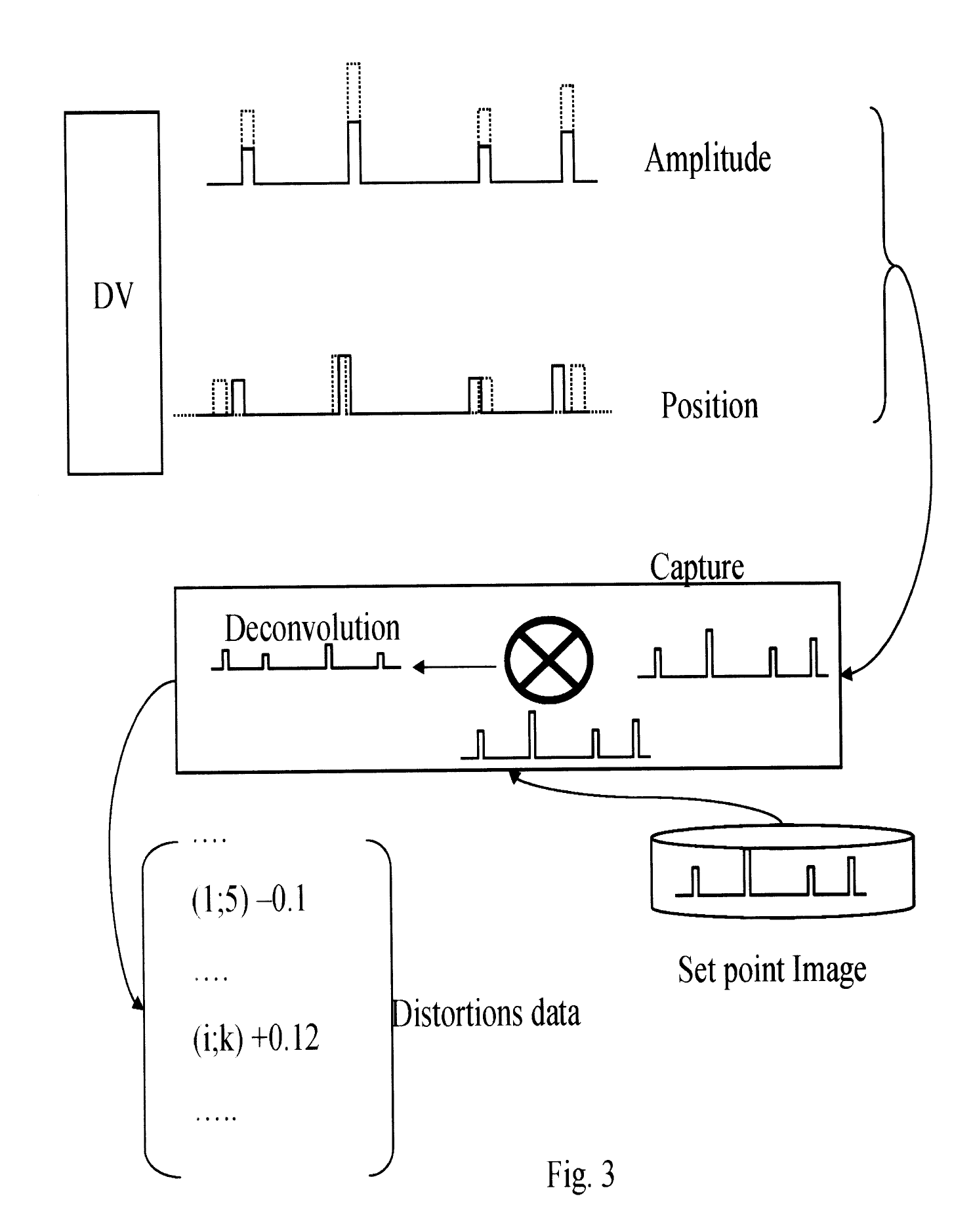

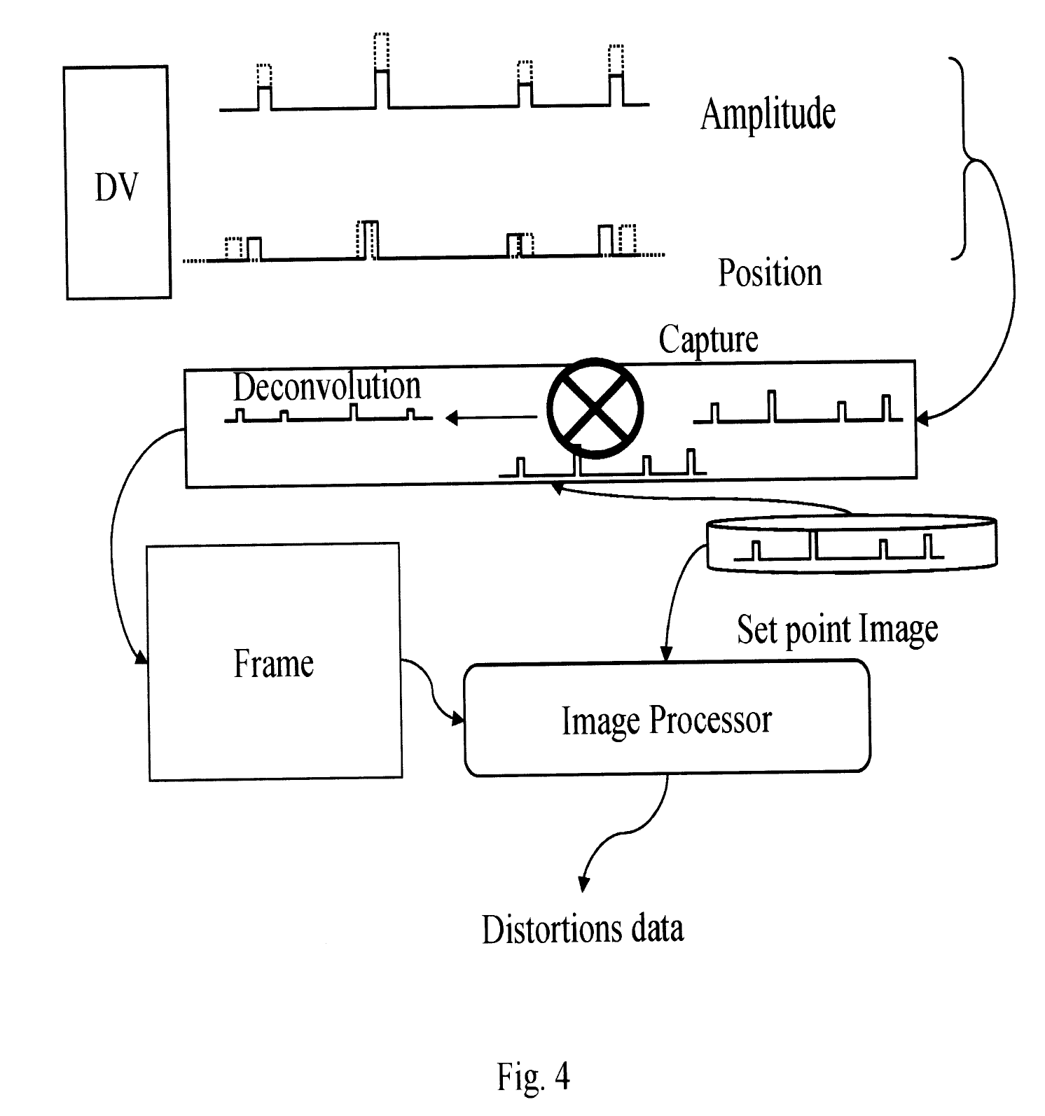

FIG. 3 shows the capture system that processes serial digital video stream. This system can be designed to perform real-time or delayed processing of DV serial protocol and compare its data versus initial set of set point data for the system. Result of such processing is a collection of time sequences of distortions for all registered events. Alternatively the capture system can convert DV serial protocol data to sequence of frames. This processing is illustrated on FIG. 4. Each frame then analyzed with imaged processing software to extract the collection of sequences of the distortion data for all registered events.

Said extraction of distortions data can be achieved using plurality of well known numerical deconvolution algorithms such as maximum entropy method, LUCY, inverse filter. Each element of optical image is constrained to relatively small segment of sensor surface (usually 10 pixels in each dimensional of the sensor). Implementation of said algorithms can achieve fast real-time response due to small window size of processing data.

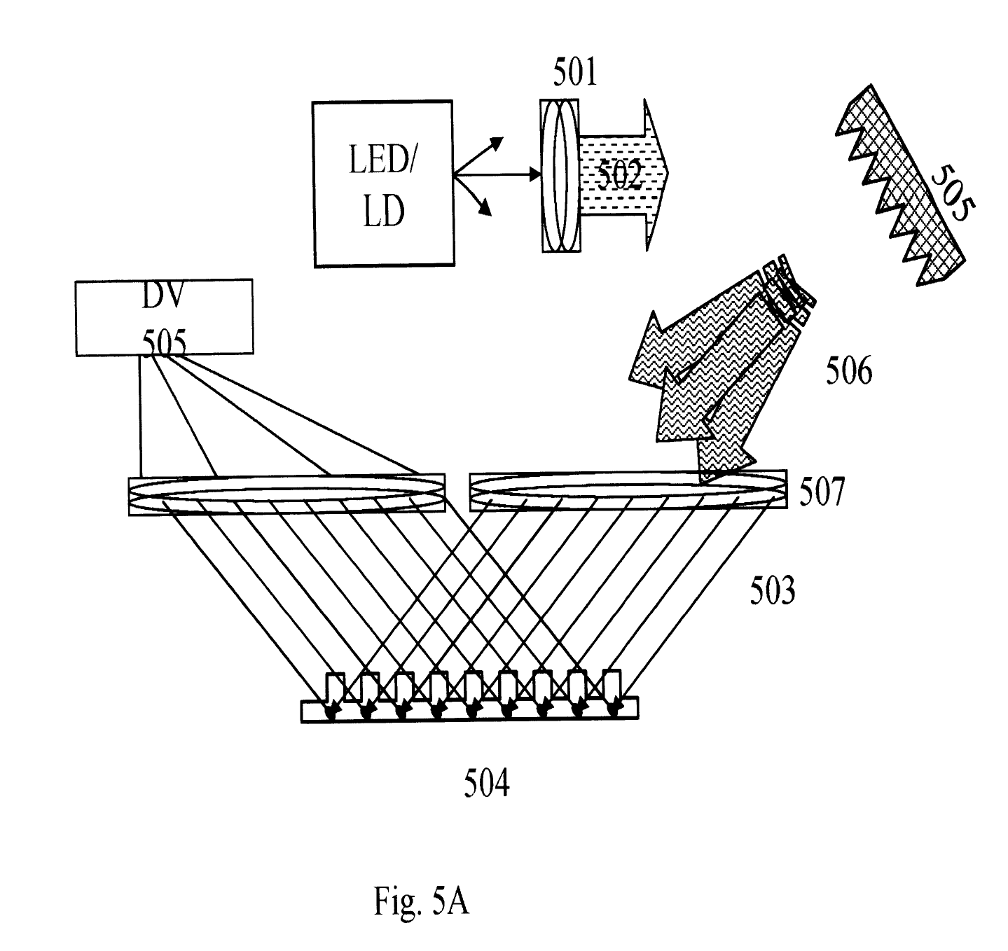

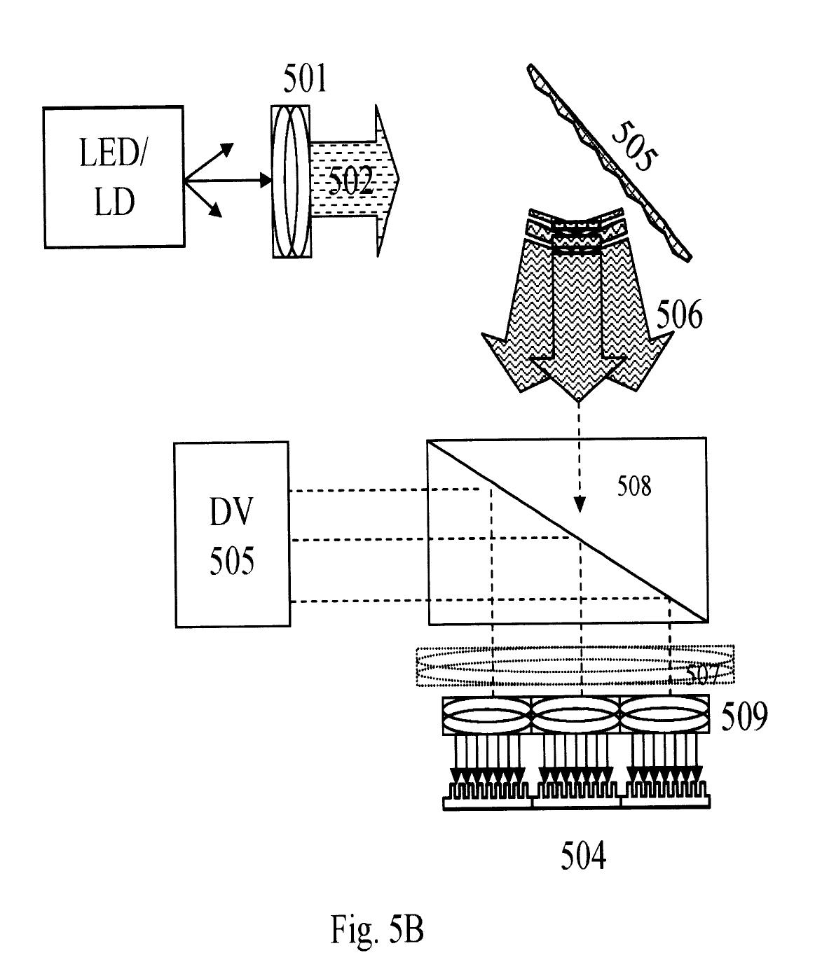

To better illustrate extraction of distortion data let's consider device shown on FIG. 5. Laser beam 502 splits onto an array 503 of N×M identical beams and said beams are focused on sample surface 504. Images of segments of sample surface exposed to laser radiation are projected onto surface of sensor 505. Let's consider that said sensor is CCD type device composed of plurality of pixels. For simplicity of the current illustration it is assumed that each image occupies single pixel of said sensor. Collection of addresses and intensity of light captured by each of exposed pixels represents initial setpoint image. Let's consider that said sample has been altered in some way that affect some of said surface segments. This alteration causes corresponding changes in images of sample surface. It is further assumed that expected changes of said images are confined to areas of Iₙ×Iₘ pixels, where each of Iₙ and Iₘ are found from periods of said beam array. This assumption effectively restricts said alterations to small values and creates geometrical clustering of complete image projected onto said sensor. As a result of said clustering said image can be represented as an uncoupled collection of independent images each of Iₙ×Iₘ pixels on size. Distortion for each of said images can be found from its comparison with previously stored setpoint image.

Complete characterization of said distortion depends on type of information essential for said process control. In some cases information required can be found as shift of position weighted average with respect to setpoint. In case when altered image contains only single pixel (it is assumed that only one pixel shows light intensity above noise level) said shift is found as geometrical distance between pixel address of setpoint image and pixel address of current image pixel. In more generic case distortion results from convolution of some altering function with initial setpoint function. To find said altering function plurality of numerical deconvolution algorithms can be used. For sake of clarity of the present disclosure no further discussion of advantages and disadvantages of specific deconvolution techniques will be made, as it is obvious to one experienced in the art that those algorithms and their implementations are readily available through public domain.

Important aspect is that complexity of said deconvolution techniques and their cost become negligible when applied to discrete functions defined on small number of points.

Examples of practical use for this apparatus include: probe arrays, where position and/or temperature of each probe has to be monitored; micro fluidics arrays where presence of liquid meniscuses, their positions, shape, temperature has to be monitored; micro plates with colored or fluorescent reactions are monitored at run time.

Massively Parallel Metrology Monitor

This apparatus comprises monochrome light source, 1D or 2D diffraction grating or custom beam splitter or diffuser or holographic device, optical components and the apparatus described in the previous embodiment. FIG. 5 illustrates construction principle of the apparatus. Light source produces light with narrow bandwidth and high spatial coherence. Optical system 501 generally represents collimator, although spatial filtering device such as holographic filter can be used to restrict radiation to specific set of modes. 501 conditions the light to form desired beam 502. The beam splits on diffractive beam splitter 505 and forms angular array of beams 506. Optical system 507 focuses these beams onto surfaces of controlled array 504. Apparatus described in the previous embodiment receives the image of reflected and/or dispersed light form the surface of array 504.

Dimensions of the beams array have high fidelity across the array. This allows monitoring of simultaneous events occurring on the target with high dimensional precision across whole field of view. In critical applications components of the apparatus including digital video camera sensor and the diffractive beam splitter can be thermally stabilized.

One special case of implementation for said apparatus uses focused laser beams. Conditioning module 501 filters single mode of laser radiation. Resulting beam 502 cloned with beam splitter 505 that create plurality of nearly identical beams. Although amplitudes of created beams generally different they all share same mode. Objective lenses 507 focus said beam array onto surface of microarray 504. It is possible in some implementation to use holographic filter combined with objective optics 507 instead of collimator 501 to perform mode filtering.

Objective optics 507 creates an array of focal points on surface of microarray 504. Numerical aperture of said objective defines width and depth of said focal points. In some application it may be favorable to use small aperture objective to create deep focal zone, such application comprise microarrays with control points spread on several planes, or arrays with relatively rough surface. Large apertures of said objective allow creation of small focal area that is favorable for high density microarrays.

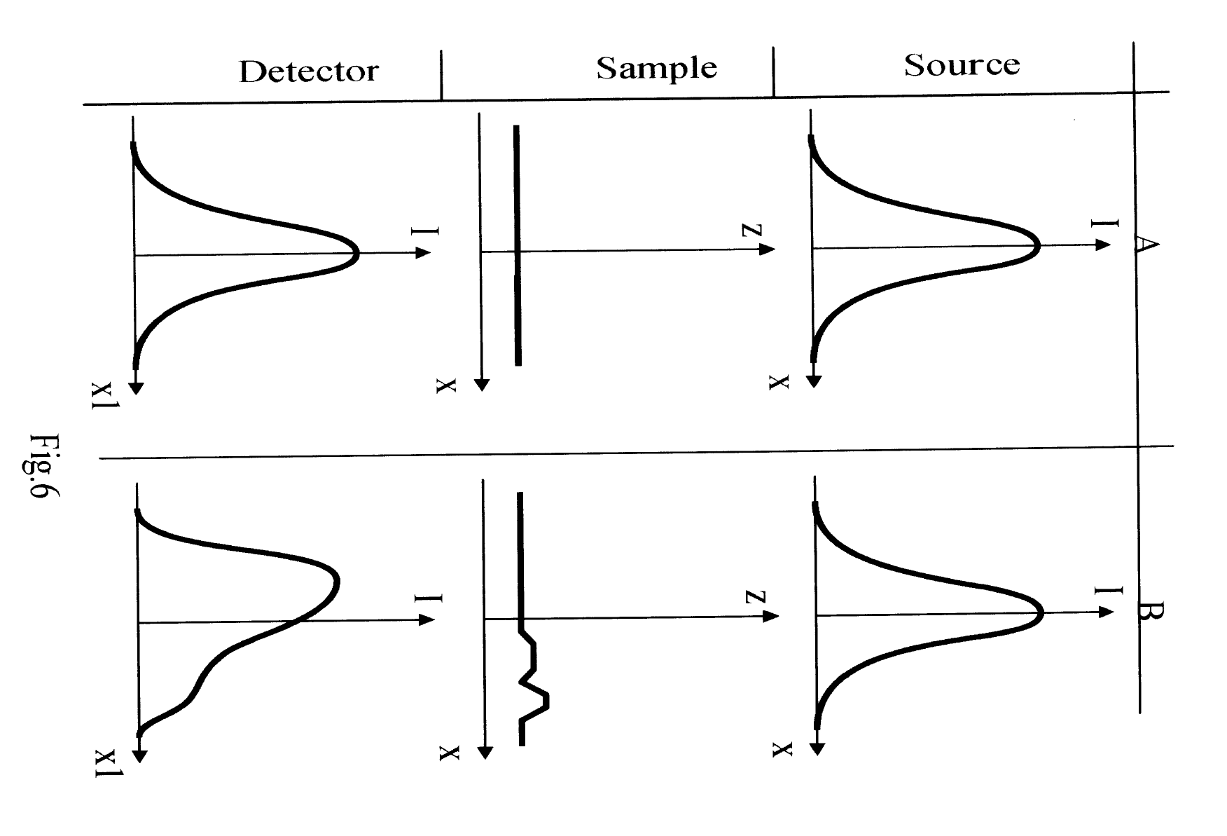

FIG. 6 illustrates principle of operation of method employed in said apparatus. Column A shows focal intensity distribution of single mode laser beam, assuming that sample surface does not contain any peculiarities, reflected image will create original intensity distribution on surface of image detector. Column B shows same segment of sample surface with deposits of some additional substance. In this case peculiarities of focal plane cause interference between different portions of reflected beam. Instead of single mode beam reflected beam now composed of multiple modes, which results in alterations of detected image. Important aspect of this invention is ability to detect even tiny peculiarities located in focal zone. These peculiarities can be formed by optically passive compounds that usually undetectable by spectroscopic techniques.

Sensitivities of described method is inversely proportional to the area of focal maximum. Thus increase in numerical aperture of objective increase method sensitivity.

FIG. 5B shows schematic view of apparatus that employs microoptical array of lenses as an objective. Use of microoptics allows larger numerical apertures that increases method sensitivity. The same microoptical elements 509 used for incoming and reflected light. semitransparent mirror 508 separates reflected light and direct it toward video sensor 505.

Possible applications of this apparatus are described below, these however only examples and do not limits application of the apparatus to these cases: i) deflections monitor for probes in probe's array of scanning probe microscopes, multi probe stamps, MEMS, wherein the deflection data then can be used in instrument tune-up, process monitoring, feedback, quality control ii) quality control of DNA microarrays, wherein distortions of beam modes caused by focal zone peculiarities are validated across complete array of deposits.

Disclosed method of the present invention limited to applications when same location of surface segment of a sample can be located at least twice to perform valid comparison of changes caused by process. In order to increase method accuracy special alignment steps can be taken in application requiring consecutive replacements of said samples. Said alignment process can be manual or automated. In manual process position of sample can be manually adjusted with respect to apparatus objective to match previous position. Automated alignment may employ micro-positioning stage that dynamically change relative position of sample.

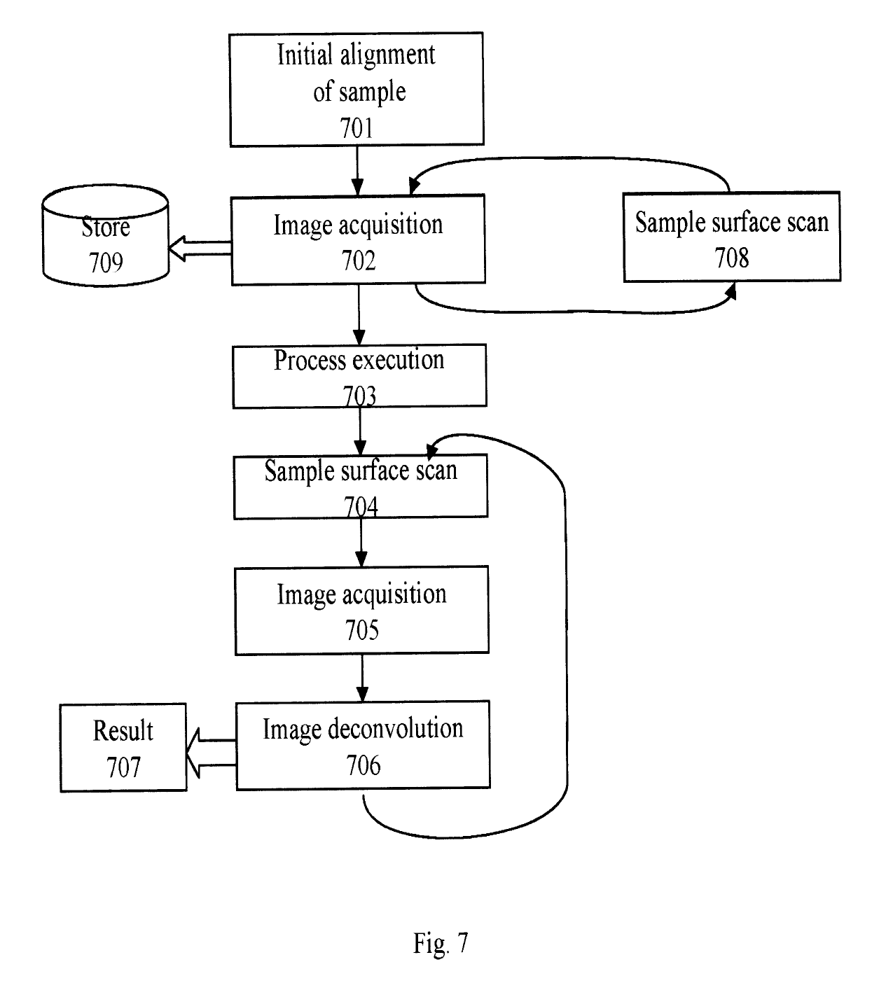

In last case the method of invention can be extended to perform distortions analysis across extended surface area of sample. FIG. 7 show block diagram of this method. Initial sample alignment 701 is performed to when sample inserted into apparatus. Sequential image acquisition 702 and scanning 798 is performed to measure unaltered state of the sample, where in said stated is recorded into digital storage 709. Process execution 703 corresponds to any technological or other functional steps applied to the sample. Examples of such steps comprise deposition of DNA droplets, engagement of array of microcantilevers in contact with other body, etc. Parallel with said process execution or after its completion sample surface is scanned 704 and sequential image acquisition 705 is performed. Distortions data is extracted 706 from said image using stored image data 709. The methods of extraction were described in the previous embodiment. Resulting distortion data 707 are employed in process control, quality monitoring, sample validation, and etc.

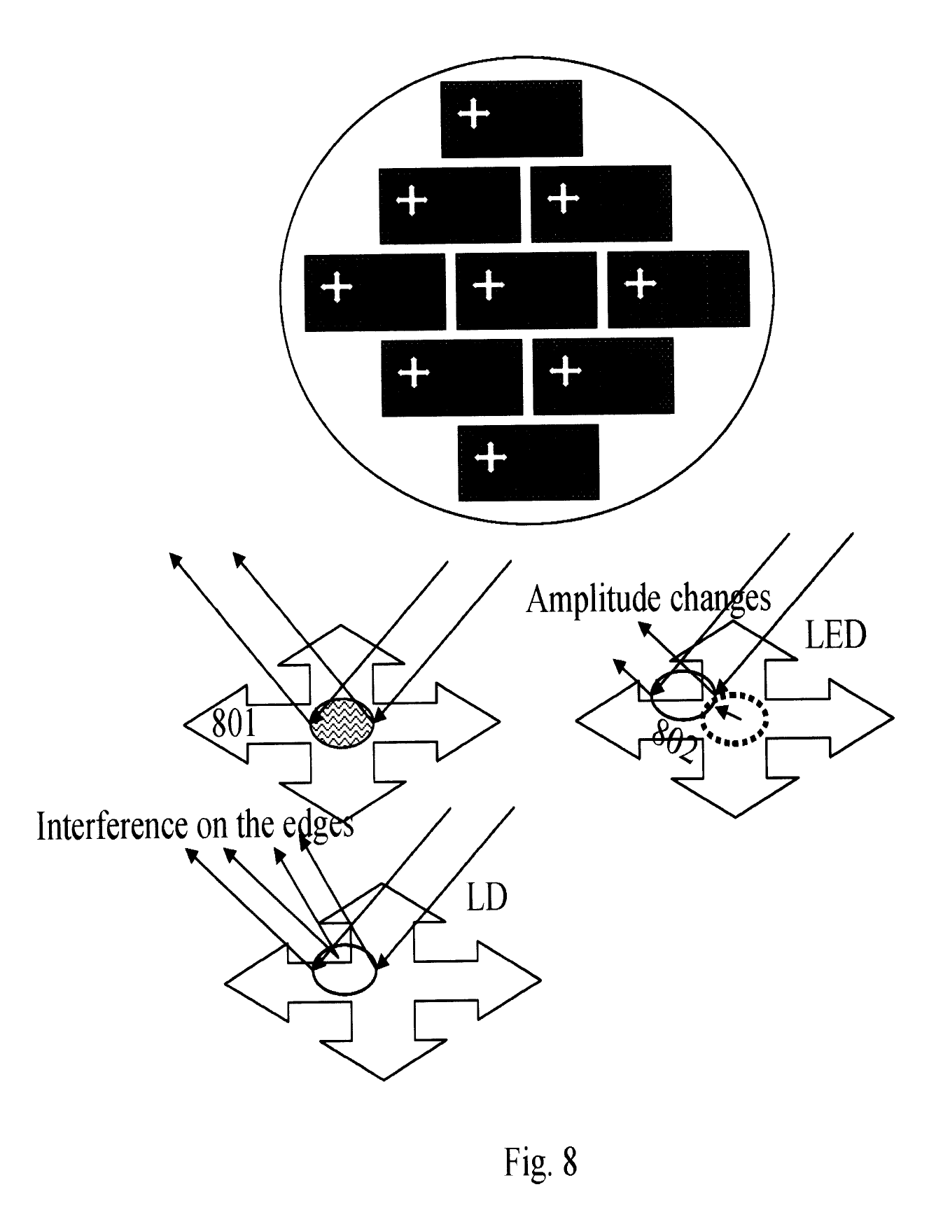

Apparatus can be used to monitor dimensional distortions of wafer in micro fabrication process. This application is illustrated on FIG. 8. Individual beams of beam array are focused on locations of alignment marks 801 on the wafer surface. Small variations in relative positions 802 of those marks cause angular and/or amplitude distortions in reflected beams that result in changes of their mode. Collection of this data can be used to compensate or correct these distortions.

Apparatus can be used in detection and monitoring of micro fluidic arrays and devices. Distortions of positions, sizes and dimensions of fluid meniscuses cause significant variations in patterns of reflected beams.

Massively Parallel Radiation Driver for Micro Scale Devices

The apparatus uses high power mono/poly-chromatic/narrow-spectrum light source. Light passes through beam splitter and each beam passes through individual element on digital light processing module. The beams are focused on surface of controlled device.

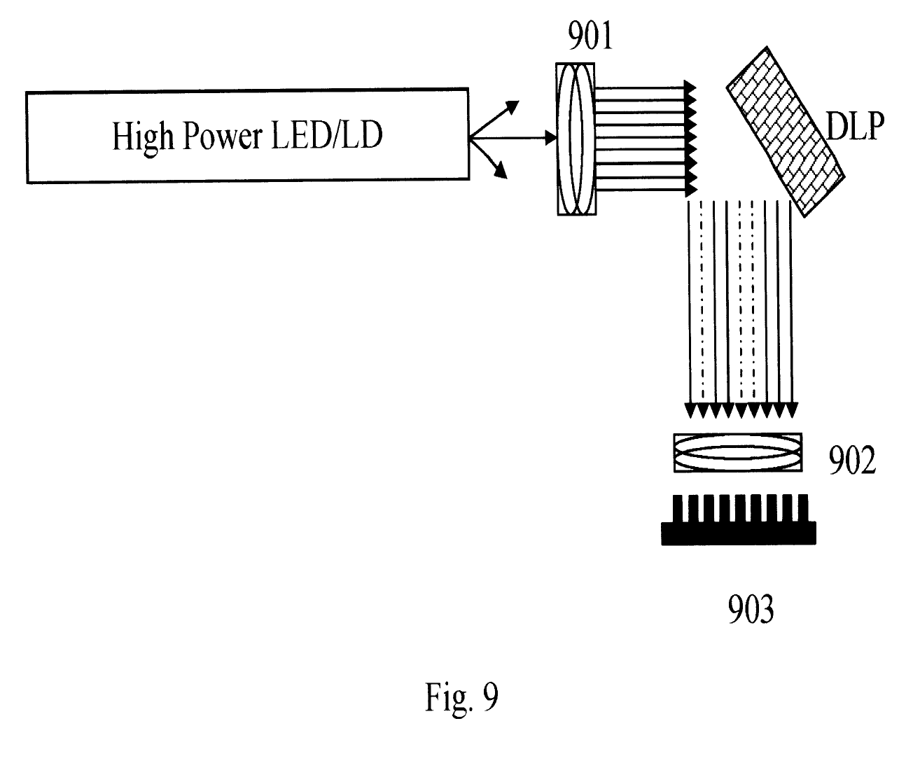

Each beam carries sufficient energy to physically actuate an element of the controlled device. Physical actuation could include conversion of laser radiation into thermal energy, use of photon pressure, photonoacoustical excitation of mechanical oscillations, photo-electrical conversion, and etc. FIG. 9 illustrates construction of such apparatus. Light from high power LED or laser diode passes through collimator and beam splitter assembly 901. It forms an array of beams. The size and pattern of this array are made to match spacing and dimensions of elements in digital light processing module DLP composed of plurality of electronically controlled micromechanical mirrors. DLP controls propagation of each individual beam. Beams passed through focal/scaling assembly 902 are focused on elements of controlled device 903.

Amount of energy delivered to each element is controlled by DLP module. This apparatus can be combined with any one of the previously described apparatuses. In combination with digital video detector described in the first embodiment, the data from detector can be used to register actual amount of energy consumed by each element. This information can be used to provide feedback to DLP and/or LED/LD modules.

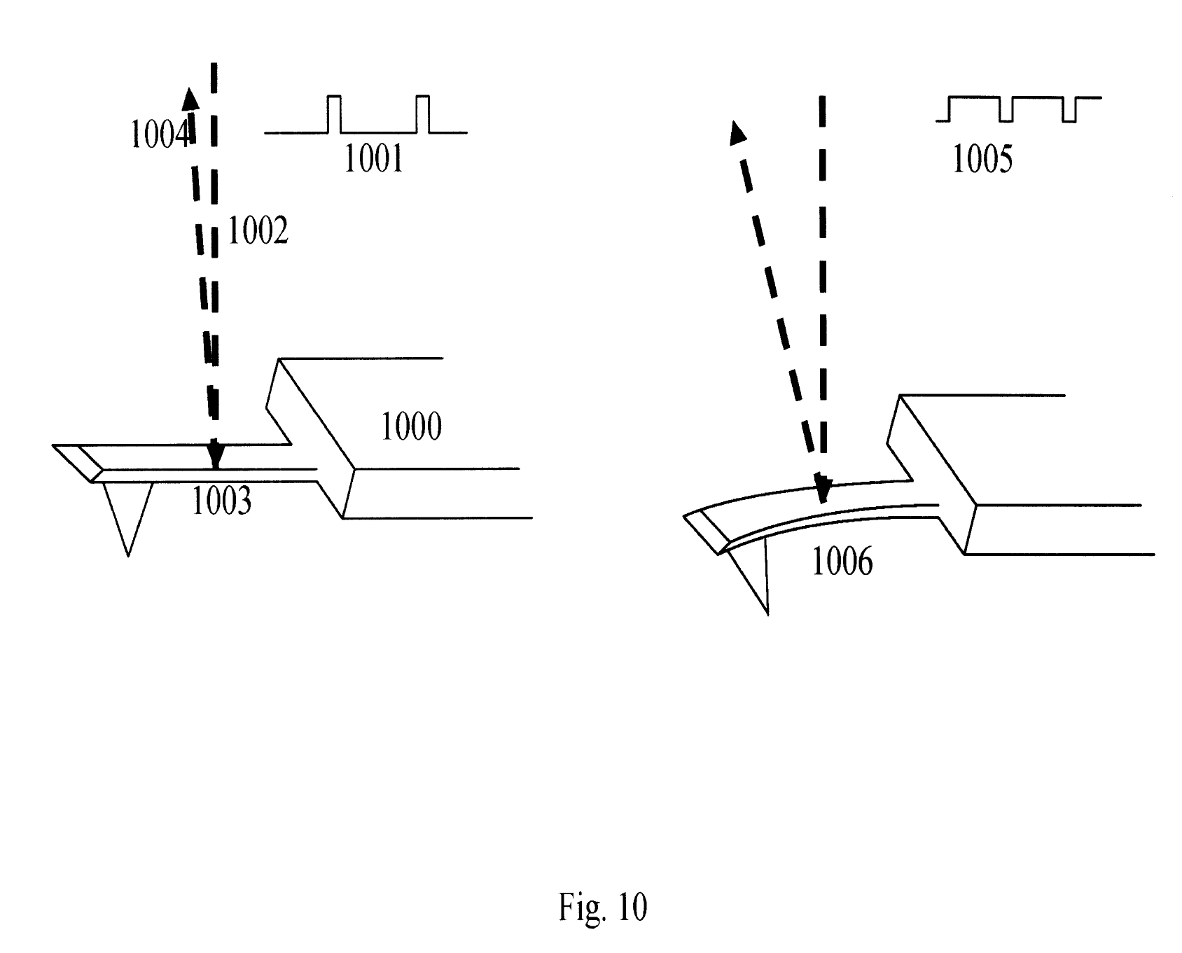

FIG. 10 illustrates use of disclosed apparatus to control array of cantilever devices. This figure shows single element 1000 of said array. DLP module generates time modulated sequence of radiation pulses 1002 with variable width. Low width pulses 1001 cause minimal effect on temperature of cantilever 1003 and its deformation. Reflected beam 1004 is captured by detector and distribution of its intensity on sensor's surface is converted to degree of cantilever deformation. Increase in pulse width 1005 causes increase in temperature of cantilever and results in deformation 1006. Increase in deformation causes offset in position of reflected image on the sensor's surface. Pulse width can be adjusted to desired value using sensory data for feedback input.

Frequently cantilever devices are used in scanning operations. In this case probe mounted on cantilever engaged in contact with underlying surface. Contact forces alters during scan due to irregularities of said surface that results in deformations of cantilever. This deformations can be registered by described video sensor and used to adjust cantilever deformation appropriately. Said adjustment can be performed using knowledge of calibration curve that shows deformation of cantilever as a function of pulse width. Said calibration is performed in position when probe withdrawn from contact with underlying sample. When in contact deviation of cantilever deformations from said calibration curve are considered as caused by force of interaction of said probe with said underlying sample.

Described method allows implementation of constant force mode of scanning process. Term constant force is well known to one experienced in art of scanning probe microscopy.

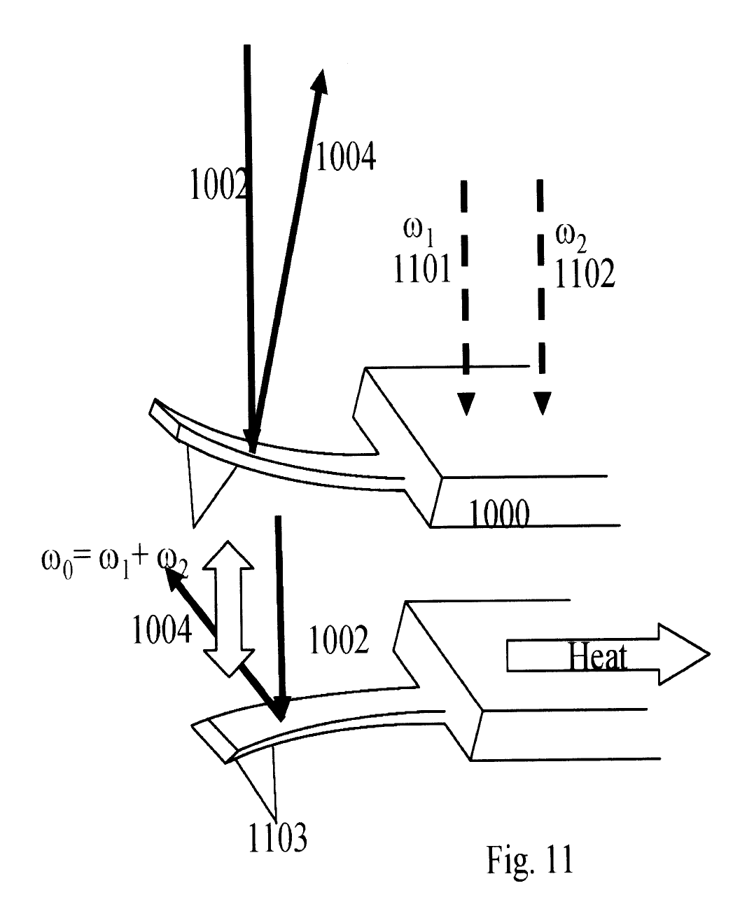

FIG. 11 shows yet another example of use of described apparatus. Shown design uses optical system that focuses three beams on each cantilever device 1000. Beam 1002 monitors deflection of said cantilever as it was described above. Beams 1101 and 1102 are focused on body of said device 1000. Beam 1101 modulated with frequency #₁ and beam 1102 modulated with frequency #₂ said modulation can be also implemented as modulation of pulse width. Absorption of said pulses produces photonoacoustic effect that generates acoustical waves in said body. One of frequencies #₁ or #₂ is adjusted to achieve resonance of mechanical oscillations of said cantilever. Resonance frequency can be found and sum or difference of #₁ and #₂. Interestingly this method uses only one sensory beam 1004. Although frequency of resonance oscillations #₀ can be several megahertz there is no need to acquire video sensor data at that high rate. Acquisition at moderate rate causes image of reflected beam 1004 to spread across several pixels at the same time. Length of said image is proportional to amplitude of oscillations. When probe 1103 experience interaction with underlying sample said image shifts that corresponds to averaged deformation of cantilever across multiple periods.

Sensory data of amplitude of oscillation and or averaged deformation can be employed as feedback input.

Massively Parallel Driver with Two Channel Parallel Detector

The apparatus consists of the radiation driver described in the previous embodiment and metrology monitor, which described early. Additionally several digital video detectors may be used to register selected types of events.

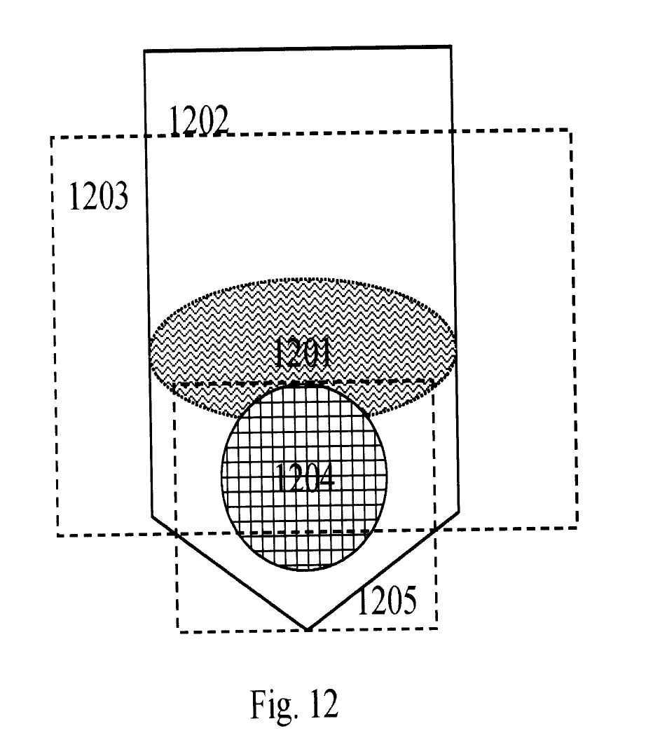

FIG. 12 shows an example application of this apparatus. It shows area of only single element of a controlled device. High power light beam is focused into area 1201. Element 1202 adsorbs parts of this energy and disperse the rest of it. Temperature of the element 1202 changes as a result of the adsorption. Changes in temperature are registered using digital video detector system described early, wherein said video detector operated in infrared. This system has focus on area 1203. The metrology monitor system focuses its beam into area 1204. Positional distortions that occur in element 1202 are registered by video detector system through monitoring area 1205.

It is possible in some applications to use high power beams in both driver and metrology applications. As well thermal measurements and dimensional distortions both can be acquired through the same digital video system.

1. Method of measurement of characteristics of a body, wherein said body comprises periodic array of more than two geometrically equivalent elements, and some or all of said elements can be absent at some moment of time, and said method comprises following:
i) digital acquisition of some fragments of image from video source at first moment of time
ii) digital acquisition of same fragments of image from video source at second moment of time
iii) comparison of individual image fragment taken at first moment of time with individual image fragment taken at second moment of time for the same fragment, wherein said comparison uses at least one pixel from said first image fragment and at least one different pixel from said second image fragment.

2. Method of claim 1 where said image fragments are directly extracted from digital video stream.

3. Method of claim 1 where said image fragments are extracted from whole single frame of digital video stream.

4. Apparatus implementing method of claim 1 and comprising:
i) laser light source and collimator
ii) spatial light modulator capable of splitting of single monochrome light beam into ordered plurality of light beams
iv) objective lens
v) video capture device capable of acquiring optical images.

5. Apparatus of claim 4 further comprising microarray of lenses.

6. Method of measurements of characteristics of a body, wherein said body comprises periodic array of more than two geometrically equivalent elements, and some or all of said elements can be absent at some moment of time, and said method comprises following:
i) source of laser radiation
ii) optical elements capable of focusing said radiation onto surface of said body
i) optical image capture device
ii) digital acquisition of some fragments of image from said capture device at first moment of time, where in said fragments contain distribution of light intensity of a beam reflected from said focal location of said body
iii) digital acquisition of same fragments of image from said capture device at second moment of time, where in said fragments contain distribution of light intensity of a beam reflected from said focal location of said body
iv) comparison of individual image fragment taken at first moment of time with individual image fragment taken at second moment of time for the same fragment, wherein said comparison uses at least one pixel from said first image fragment and at least one different pixel from said second image fragment.

7. Method of claim 6 where said image fragments are directly extracted from digital video stream.

8. Method of claim 6 where said image fragments are extracted from whole single frame of digital video stream.

9. Apparatus implementing method of claim 6 and comprising:
i) laser light source and collimator
ii) spatial light modulator capable of splitting of single monochrome light beam into ordered plurality of light beams
vi) objective lens
vii) video capture device capable of acquiring optical images.

10. Apparatus of claim 9 further comprising microarray of lenses.

11. Method of claim 6 further comprising scanning of said body surface with respect to said focusing optical elements.

12. Apparatus of claim 9 or clam 10 further implementing method of claim 10 and further comprising lateral positioning stage with positioning plane parallel to said objective lens/lenses.

13. Method of controlling operations of plurality of micromechanical or micro electromechanical elements representing parts of single device, wherein said method comprises:
i) use of laser light source with output power more that five (5) milliwatt
ii) splitting said light onto plurality of beams
iii) controlling propagation of said beams using electronically controlled optical switching device
iv) focusing said beams onto surface of said device.

14. Apparatus implementing method of claim 13 and comprising:
i) laser light source
ii) plurality of optical elements
iii) electronically controlled optical switching device.

15. Method of measuring deformations of plurality of microcantilevers that employs method of claim 6.

16. Method of creation of controlled deformation of microcantilevers that comprises:
i) array of microcantilevers, wherein each cantilever has light beam focused in its surface
ii) said light beam is modulated by intensity using pulse width modulation,
wherein change in modulated width results in change of deflection of said cantilever.

17. Method according to claim 16 further employing method of claim 15, wherein same light beam used in both methods.

18. Method according to claim 17 that employs measurements of method of claim 6 to establish feedback that controls cantilever deflection.

19. Method of generation of resonance oscillation of micro cantilever element, wherein said cantilever comprises body and attached integral lever, and wherein said method comprises:
i) first radiation beam focused on surface of said cantilever and modulated with first frequency
ii) second radiation beam focused on surface of said cantilever and modulated with second frequency
iii) said frequencies are adjusted so one of them or their harmonics nearly match resonance frequency of said lever.

20. Apparatus that implements method of claim 19 to produce oscillation of plurality of cantilever elements.
